(19) United States
(12) Patent Application Publication
(10) Pub. No.: US 2011/0024472 A1
(43) Pub. Date: Feb. 3, 2011

(54) Attachment for Loading Elongated Articles Atop Vehicles

(76) Inventors: Dee D. Thompson, (US); Virginia Elizabeth Thompson, Sun Prairie, WI (US)

Correspondence Address: Novak Druce & Quigg LLP, 300 New Jersey Ave, NW, Fifth Floor, Washington, DC, 20001, US

(21) Appl. No.: 12/510,473

(22) Filed: Jul. 28, 2009

(51) Int. Cl. B60R 9/042; B60R 9/045; B60R 9/06

(52) U.S. Cl. 224/500; 224/310; 224/519; 224/509

(57) ABSTRACT

An attachment for a vehicle effective in facilitating the loading of an elongated article onto the roof of such vehicle, generally consisting of a support means mountable on an end of the vehicle; a bracket mounted on the support means; a roller mounted on the bracket, having a rotation axis disposed transversely relative to a longitudinal centerline of the vehicle, onto which an end of an article may be rested to accommodate the lifting of an opposite end thereof and rolling the article onto the roof of the vehicle.

This invention relates to an attachment for a vehicle and more particularly to such an attachment which is effective in facilitating the loading of an elongated article onto the roof of a vehicle.

### BACKGROUND OF THE INVENTION

Often, for transportation purposes, it is desirable to load various elongated articles which may not be readily insertable into the passenger or trunk compartments of a vehicle, such as ladders, bolts, canoes, skis and the like, onto the roof of a vehicle. Typically, such articles are manually hoisted onto the roof of a vehicle, positioned so as not to displace and secured in place with ropes, elastic lines and the like. Because of the weight, size and/or configurations of such articles, it usually is difficult for a single person and often two persons to hoist such an article onto the roof of a vehicle, position it on the roof and secure it in position. Accordingly, it is the principal object of the present invention to provide an attachment for a vehicle which is effective in facilitating the hoisting and mounting of an elongated article onto the roof of a vehicle. It further is an object of the present invention to provide such an attachment which may be utilized by a single individual for hoisting and positioning such an elongated article on the roof of a vehicle. A still further object of the present invention is to provide such an attachment which is simple in construction, easy to manufacture, convenient to attach onto a vehicle and detach therefrom and adapted to be readily disassembled and stored in the trunk of a vehicle or elsewhere.

### SUMMARY OF THE INVENTION

The principal and other objects of the present invention are achieved by providing an attachment for a vehicle effective in facilitating the loading of an elongated article onto the roof of a vehicle, generally comprising a support means mountable on an end of the vehicle having an erect section, a bracket mounted on the support means and a roller mounted on such bracket onto which an end of such elongated article may be rested, permitting an opposite end of such article to be lifted and pushed forwardly to position the article longitudinally atop the roof of the vehicle. Such a support means may consist of a section supported on a lower end portion of a vehicle and an erect section supporting such a roller, or a member supporting such a roller mounted on an end of the vehicle roof. In either embodiment, the rotation axis of the roller is positioned substantially transversely to the longitudinal centerline of the vehicle to permit the elongated article to be guided on such roller to a longitudinal position on the roof of the vehicle. Such bracket further may be provided with means to secure a line overlying an elongated article resting on such roller to secure the article atop the vehicle.

### BRIEF DESCRIPTION OF THE DRAWINGS

FIG. 1 is a perspective view of a vehicle having a canoe mounted thereon utilizing an attachment embodying the present invention;

FIG. 2 is a enlarged, perspective view of a rear portion of the vehicle shown in FIG. 1, illustrating the manner in which the attachment is secured to the vehicle and further the manner in which the canoe is supported on the attachment;

FIG. 3 is a perspective view of the attachment shown in FIGS. 1 and 2, illustrating the components thereof in exploded relation;

FIG. 4 is a side elevational view of the attachment shown in FIGS. 1 through 3, illustrating the manner in which such attachment may be used to facilitate the hoisting and loading of a canoe onto a vehicle; and

FIG. 5 is a perspective view of a portion of a vehicle, equipped with an attachment comprising another embodiment of the present invention.

### DETAILED DESCRIPTION OF THE EMBODIMENTS OF THE INVENTION

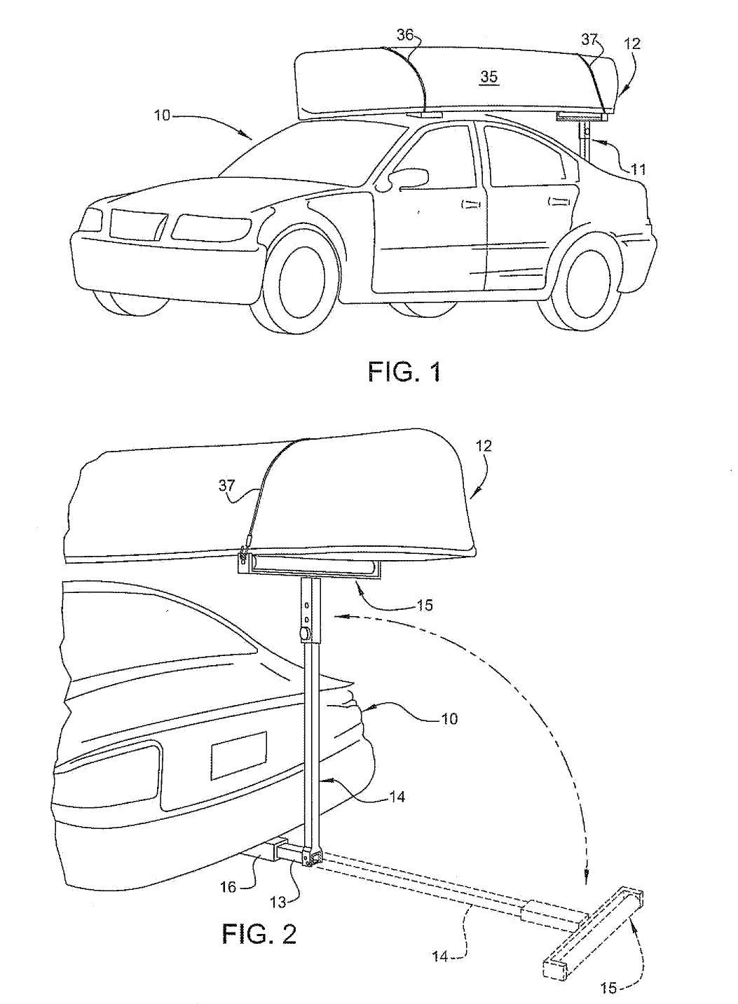

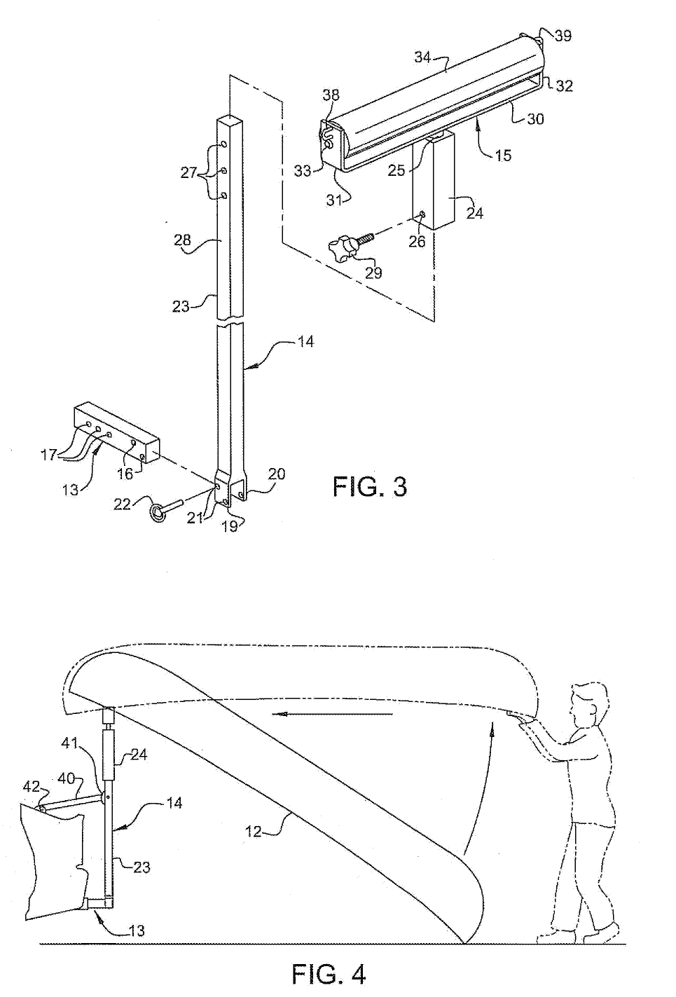

Referring to FIGS. 1 through 4, there is illustrated a vehicle 10 provided with an attachment 11 embodying the present invention and a canoe 12 which may be loaded onto and supported by use of attachment 11. As best shown in FIG. 3, attachment 11 includes a base member 13, elongated member 14 and a bracket 15. Base member 13 has a box beam configuration and is insertable at one end into a conventional hitch 16 provided at the lower rear end of vehicle 10. The side walls of member 13 are provided with a set of longitudinally spaced bolt receiving openings 17 to permit the base member to be detachably secured to the hitch by means of one or more bolts inserted through registered openings in the hitch and the base member, in the conventional manner. The intended exposed end of base member 13 further is provided with a set of bold openings 18 for connecting a lower end of elongated member 14.

Elongated member 14 also is of a box beam construction, having a pair of depending side wall portions 19 and 20 which are adapted to receive the free end of base member 13. Such side wall portions 19 and 20 further are provided with sets of openings 21 which are adapted to register with openings 18 of base member 13 when elongated member 14 is positioned on the end of the base member with the end of the base member being received between depending side wall portions 19 and 20. With base member 13, it may be detachably secured in an upright position by inserting a set of retainer bolts 22 in aligned openings 18 and 21.

The elongated member 14 includes a lower section 23 and an upper section 24 which are telescopically connected together. Section 24 also is of a box beam construction having an inner cross-sectional area slightly larger than the cross-sectional area of section 23 for receiving an end of section 23 therein, in the conventional manner. A side wall 25 of section 24 is provided with a threaded opening 26 which is adapted to register with one of a plurality openings 27 provided in a side wall 28 of section 23 when section 24 is telescopically connected to section 23. Section 24 may be secured to section 23 at different positions to vary the length of member 14 by registering opening 26 with one of openings 27, inserting a threaded retainer bolt through an opening 27 and threading it into registered opening 26. Retainer bolt 29 is provided with a knob portion which may be readily gripped and turned to secure the sections of member 14 in their desired positions.

Bracket 14 includes an elongated section 30 connected to the upper end of section 24 and a pair of end portions 31 and 32 providing a U-shaped configuration. Disposed in an aligned set of openings in end sections 31 and 32 is a shaft 33 on which there is provided rotatable roller 34. Bracket 30 is mounted relative to member 14 so that when the attachment is mounted on vehicle 10 in the manner as shown in FIG. 2, the axis of rotation of roller 34 will be disposed substantially transversely relative to the longitudinal centerline of the vehicle.

When disassembled, attachment components 13, 14 and 15 may be stored in the trunk compartment of the vehicle or elsewhere. When it is desired to utilize the attachment to load and transport an article such as canoe 12, the attachment may be assembled by first securing base member 13 in hitch 16 and firmly securing it thereto, telescopically mounting section 24 with bracket 15 on the end of section 14, adjusting the relationship between sections 23 and 24 of member 14 to the desired length and securing them together by means of threaded retainer 29, pivotally connecting member 14 to base member 13 as shown in phantom lines in FIG. 2, pivoting member 14 upwardly to the position as shown in solid lines in FIG. 2, substantially perpendicular to base member 13, and then inserting retainer pin 22 in registered openings in members 13 and 14 to secure member 14 in an upright position with roller 14 being disposed transversely, rearwardly of the vehicle, and at a level at or slightly above the level of the vehicle roof. In such condition, the attachment is postured to be used to facilitate the loading of canoe 12 onto the roof of the vehicle.

With the attachment mounted on the vehicle as described and as shown in FIG. 4, the canoe may be hoisted and positioned on the roof of the vehicle by inverting the canoe, lifting and positioning a front end of the canoe on roller 34, as shown in FIG. 4, lifting the rear end of the canoe to a level so that the bottom of the canoe is disposed substantially horizontally in a plane slightly above the roof of the vehicle, and then pushing the canoe forwardly on roller 34 until the canoe is positioned atop the vehicle as shown in FIGS. 1 and 2. Prior to moving the canoe forwardly on roller 34 to position it on the vehicle, a seating device 35 may be placed on the forward end of the vehicle roof on which the front end of the canoe may rest. To secure the canoe on the vehicle spanned between the roof top and roller 34, a pair of ropes or flexible bands 36 and 37 may be employed, each overlying the hull of the canoe and having their ends attached either to seating device 35 or bracket 15. As best shown in FIG. 3, bracket 15 includes a pair of eyelets 38 and 39 to which the ends of rope or flexible line 37 may be secured.

When it is desired to unload the canoe, the loading procedure as described essentially is reversed. First, retaining lines 36 and 37 are removed. The front end of the canoe is then lifted slightly and the canoe is moved rearwardly on roller 34, and then allowed to rest on the roof of the vehicle. With the canoe thus positioned, the user may then go to the rear of the vehicle, grasp the rear overhanging portion of the canoe, tip the front end upwardly off of the vehicle roof, roll the canoe rearwardly to the position as shown in phantom lines in FIG. 4, lower the rear end of the canoe to the ground and then grasp and remove the front end of the canoe from roller 34 and place it on the ground. The attachment then may be disassembled by removing retainer 29 and pin 22, pivoting member 14 to the position shown in phantom lines in FIG. 2, detaching member 14 from base member 13, removing bracket 15 from member 14, removing base member 13 from hitch 16 and then gathering such disassembled components and perhaps storing them in the trunk compartment of the vehicle.

Bracket 15 may be rigidly connected to the end of section 24 or swivelly connected to such section. Provided with a swivel connection between bracket 15 and support member 14, when the attachment is in the assembled condition as shown in FIG. 4, it would be possible to load the canoe from a position other than a position directly behind the vehicle. Such capability may prove useful in circumstances where the area directly behind the vehicle is obstructed or it may be more convenient to begin loading the canoe from a position aside from the longitudinal centerline of the vehicle.

In normal circumstances, the attachment in the assembled condition as shown in FIGS. 1 and 2 and ropes or straps 36 and 37 should be sufficient to secure an article being transported on the vehicle. To provide additional support and rigidity to the assembly, a reinforcing or rigidifying strut 40 may be used as shown in FIG. 4. Strut 40 is formed of a rigid material, is connected, preferably pivotally, to support section 23 as at 41 and is provided with a means 42 at the opposite end thereof which may be connected to the vehicle. Preferably, connecting means 32 consists of a suction cup which may be easily connected to or removed from the upper surface of the trunk lid.

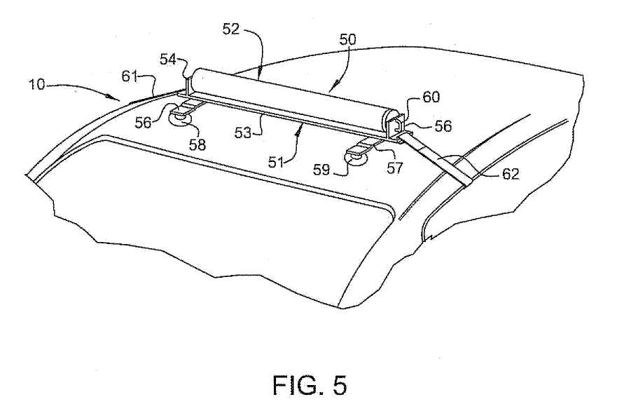

Referring to FIG. 5 of the drawings, there is illustrated an attachment 50 embodying the present invention which may be mounted directly onto the rear end of the vehicle roof in lieu of a hitch of the vehicle as in the embodiment shown in FIGS. 1 through 4. Attachment 50 essentially consists of a bracket 51 supporting a roller 52. Bracket 51 includes an elongated planar section 53 provided with a pair of opposed end sections 54 and 55. Provided on the underside of planar section 53 is a pair of support legs 56 and 57 on which there are provided sets of suction cups 58 and 59. Similar to the previously described embodiment of the invention, a shaft 60 is supported on end sections 54 and 55 of the bracket on which roller 52 is rotatably mounted.

Attachment 50 is intended to be positioned on the rear end of the vehicle roof, disposed transversely, secured to the vehicle roof by suction cups 58 and 59 and further secured thereto by means of a set of straps 61 and 62 connected to end sections 54 and 55, respectively, and attachable at their free ends to portions of the vehicle. End sections 54 and 55 further are provided with eyelets as in the previously described embodiment to accommodate a rope or strap for securing an article loaded on the vehicle and being transported.

Attachment 50 essentially may be used in the same manner as attachment 11. In lieu of being attached to the hitch of the vehicle, attachment 10 is mounted and secured to the rear end of the vehicle roof as shown in FIG. 5. With it so positioned, the canoe may be mounted on the vehicle roof by inverting the canoe, lifting the front end and placing it on roller 52, lifting the rear end of the canoe and moving it forwardly onto the roof top on roller 50. After the canoe is properly positioned atop the roof, it may be secured to the roof top in a manner as previously described. To remove the canoe, the procedure as described essentially is reversed. Attachment 51 simply may be left on the roof of the vehicle or easily removed and stored by pulling it away from the roof to break the suction attachment, and storing it in the trunk compartment. In some applications, attachment 51 may be preferable to attachment 11 in that it is simpler in construction, more easily mounted on the vehicle and perhaps more robust in use. However, it may not be as suitable in effectively supporting elongated articles of substantial length.

The attachments as described may be fabricated of any suitable materials although it is preferred that the structural components thereof be formed of a metal such as steel or aluminum. The rollers may be formed of a metal, a plastic, wood or any suitable material which is compatible with the types of articles to be accommodated.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

I claim:

1. An attachment for a vehicle effective in facilitating the loading of an elongated article onto the roof of said vehicle, comprising:
support means mountable on an end of said vehicle;
a bracket mounted on said support means; and
a roller mounted on said bracket, having a rotation axis disposed transversely relative to a longitudinal centerline of said vehicle, onto which an end of said article may be rested to accommodate the lifting of an opposite end thereof and rolling said article onto the roof of the vehicle.

2. An attachment according to claim 1 wherein the length of said support means is adjustable.

3. An attachment according to claim 2 including means for detachably securing said support means in selected lengths.

4. An attachment according to claim 1 wherein said bracket is detachably securable to said support means.

5. An attachment according to claim 1 wherein said bracket includes a pair of spaced means to which a line securing said article resting on said roller may be secured, to secure said article disposed on said roof.

6. An attachment according to claim 5 wherein said spaced securing means comprise eyelets to which ends of a line overlying said article may be secured.

7. An attachment according to claim 1 wherein said support means includes a pair of sections telescopically connected together.

8. An attachment wherein said telescopically connected sections are formed of a metal having box beam configurations.

9. An attachment according to claim 8 including means for detachably securing said telescopically connected sections in selected lengths.

10. An attachment according to claim 1 including a support strut interconnectable between said support means and a portion of said vehicle.

11. An attachment according to claim 1 wherein said support means includes a base member connectable to a hitch of said vehicle and an elongated erect member connected at a lower end thereof to said base member.

12. An attachment according to claim 11 wherein the length of said elongated erect member is adjustable.

13. An attachment according to claim 12 including means for detachably securing said elongated erect member in selected lengths.

14. An attachment according to claim 11 wherein said bracket is detachably securable to said elongated erect member.

15. An attachment according to claim 11 wherein said bracket includes a pair of spaced means to which a line securing said article resting on said roller may be secured, to secure said article disposed on said roof.

16. An attachment according to claim 15 wherein said spaced securing means comprise eyelets to which ends of a line overlying said article may be secured.

17. An attachment according to claim 11 wherein said elongated erect member includes a pair of sections telescopically connected together.

18. An attachment wherein said telescopically connected sections are formed of a metal having box beam configurations.

19. An attachment according to claim 18 including means for detachably securing said telescopically connected sections in selected lengths.

20. An attachment according to claim 19 including a support strut interconnectable between said elongated erect member and a portion of said vehicle.

21. An attachment for a vehicle effective in facilitating the loading of an elongated article onto the roof of said vehicle, comprising:
a bracket mountable on an end of the roof of said vehicle; and
a roller mounted on said bracket.

22. An attachment according to claim 21 wherein said bracket is mountable on said bracket on said roof so that the axis of rotation of said roller is substantially transverse in relation to a longitudinal centerline of said vehicles.

23. An attachment according to claim 22 wherein said bracket is detachably mountable on said vehicle roof.

24. An attachment according to claim 22 wherein said bracket is provided with at least one suction cap for detachably securing said bracket to said vehicle roof.

25. An attachment according to claim 22 wherein said bracket includes means for securing a line overlying said article when restoring on said roller.
